(19) United States
(12) Patent Application Publication
(10) Pub. No.: US 2023/0061100 A1
(43) Pub. Date: Mar. 2, 2023

(54) OPTICAL FIBRE PREFORM AND METHOD OF MANUFACTURING THEREOF

(71) Applicant: Sterlite Technologies Limited, Gurgaon (IN)

(72) Inventors: Badri Gomatam, Gurgaon (IN); Nivedita Prasad, Gurgaon (IN); Chandan Saha, Gurgaon (IN)

(21) Appl. No.: 17/553,094

(22) Filed: Dec. 16, 2021

(30) Foreign Application Priority Data
Aug. 27, 2021 (EP) 20748830.5

(51) Int. Cl. C03B 37/012

(52) U.S. Cl. CPC C03B 37/01211; C03B 37/01248; C03B 37/01265; C03B 37/0128; C03B 2201/12; C03B 2203/22

(57) ABSTRACT

A reduced diameter optical fibre preform positioned along a longitudinal axis includes a core section defined around the longitudinal axis and a cladding section circumferentially surrounding the core section. The reduced diameter optical fibre preform is manufactured by utilizing a calcium aluminum silicate rod and a fluorine doped glass cylinder.

### FIELD OF THE INVENTION

Embodiments of the present invention relate to the field of optical communication technology. And more particularly, relates to a reduced diameter optical fibre preform and method of manufacturing the reduced diameter optical fibre preform.

### BACKGROUND

Over the last few years, there has been an exponential rise in manufacturing of optical fibres due to an overgrowing demand of the optical fibres. Particularly, the manufacturing of optical fibres has two major stages. The first stage involves the manufacturing of optical fibre preforms and the second stage involves drawing the optical fibres from the optical fibre preforms. In general, the quality of optical fibres depends on conditions of manufacturing. So, a lot of attention is paid towards the manufacturing of the optical fibre preforms. These optical fibre preforms include an inner glass core surrounded by one or more glass cladding layers having a lower index of refraction than the inner glass core. The core and cladding are formed of different materials. The thermal properties of the cladding are very different from the thermal properties of the core.

Typically, the preform is manufactured by utilizing a substrate rod and a plurality of burners positioned below the substrate rod. The plurality of burners traverse along a length of the rotating substrate rod or the substrate rod rotates and traverses back and forth on top of the plurality of burners or both may traverse relatively to each other.

The presently available techniques for the production of the optical fibre preform have certain drawbacks. One of the most consistent problems which occur during the production process is the formation of undulations along the length of the optical fibre preform. The undulations are formed during the deposition process. And these undulations correspond to places of non-uniform deposition or places of alternating excess and meagre deposition.

Another problem associated with production of the optical fibre preform is the high manufacturing cost of optical fibre preforms due to manufacturing of multiple cladding layers. The multiple cladding layers increases the manufacturing cost as well as manufacturing time of the optical fibre preforms. Another problem is the large diameter of the optical fibre preforms. The large diameter of the optical fibre preform is also due the multiple cladding layers.

Thus, in light of the above stated discussion, there is a need to develop an optical fibre preform that overcomes the above stated disadvantages and provides ease in manufacturing. Hence, the present invention focuses on an optical fibre preform and a method thereof.

### SUMMARY OF THE INVENTION

Embodiments of the present invention relates to a reduced diameter optical fibre preform with reduced diameter and a method of manufacturing thereof. Particularly, the reduced diameter optical fibre preform is used for manufacturing optical fibre with reduced losses. The reduced diameter optical fibre preform includes a core section and a cladding section. The core section is defined around a longitudinal axis of the reduced diameter optical fibre preform. In addition, the core section extends radially outward from the longitudinal axis of the reduced diameter optical fibre preform. Further, the cladding section circumferentially surrounds the core section of the reduced diameter optical fibre preform.

In accordance with an embodiment of the present invention, the core section is made of calcium aluminum silicate.

In accordance with an embodiment of the present invention, the core section has a first refractive index of 1.625

In accordance with an embodiment of the present invention, the core section of the optical fibre preform has a coefficient of thermal expansion of 5.1×10⁻⁶ per Kelvin.

In accordance with an embodiment of the present invention, the core section has a glass transition temperature of 830 degree Celsius.

In accordance with an embodiment of the present invention, the cladding section is made of a fluorine doped glass.

In accordance with an embodiment of the present invention, the cladding section is made of an aluminium silicate.

In accordance with an embodiment of the present invention, the cladding section has a second refractive index 1.54.

In accordance with an embodiment of the present invention, the cladding section of the optical fibre preform has a coefficient of thermal expansion of 4.7×10⁻⁶.per Kelvin.

In accordance with an embodiment of the present invention, the cladding section of the optical fibre preform has a glass transition temperature of 790 degree Celsius.

In accordance with an embodiment of the present invention, the cladding section has a density of 2.7 grams per cubic centimeters.

In accordance with an embodiment of the present invention, the core section has a density of 2.8 grams per cubic centimeters.

In accordance with an embodiment of the present invention, the core section is characterized by an attenuation, and the core section has the attenuation of 0.1 decibel per kilometer.

In accordance with an embodiment of the present invention, the reduced diameter optical fibre preform has an outer diameter of 41 millimeters.

Another embodiment of the present invention relates to a method for manufacturing a reduced diameter optical fibre preform. The method of manufacturing includes at least one of a fluorine doped glass cylinder and a calcium aluminum silicate rod. The fluorine doped glass cylinder is a hollow cylinder. In addition, the fluorine doped glass cylinder is heated and collapsed onto a calcium aluminum silicate rod. Further, the calcium aluminum silicate rod is placed inside the fluorine doped glass cylinder. Furthermore, the fluorine doped glass cylinder containing the calcium aluminum silicate rod is heated from outside to enable manufacturing of the reduced diameter optical fibre preform. The fluorine doped glass cylinder and a calcium aluminum silicate powder. The fluorine doped glass cylinder is filled compactly with the calcium aluminum silicate powder. In addition, the calcium aluminum silicate powder solidifies and adheres smoothly with the fluorine doped glass cylinder after sintering to manufacture the optical fibre preform. The fluorine doped glass cylinder and a molten calcium aluminum silicate. In addition, the fluorine doped glass cylinder is filled compactly with melted calcium aluminum silicate. Further, melted calcium aluminum silicate adheres smoothly with the fluorine doped glass cylinder after cooling to enable the reduced diameter optical fibre preform.

In accordance with an embodiment of the present invention, the fluorine doped glass cylinder has an internal diameter in the range of 26 millimeters to 28 millimeters.

In accordance with an embodiment of the present invention, the calcium aluminum silicate rod is placed inside the fluorine doped glass cylinder.

In accordance with an embodiment of the present invention, the fluorine doped glass cylinder containing the calcium aluminum silicate rod is heated from outside to enable the reduced diameter optical fibre preform.

In accordance with an embodiment of the present invention, the calcium aluminum silicate powder solidifies and adheres smoothly with the fluorine doped glass cylinder after sintering for manufacturing of the reduced diameter optical fibre preform.

In accordance with an embodiment of the present invention, the reduced diameter optical fibre preform has an outer diameter of 41 millimeters.

In accordance to another embodiment of the present invention, the optical fibre preform includes a core section and a cladding section. The core section is defined along a longitudinal axis of the optical fibre preform is made of calcium aluminium silicate and has a first refractive index n₁. Moreover, the cladding section circumferentially surrounds the core section of the optical fibre preform is made of aluminium silicate and has a second refractive index n₂.

The foregoing objectives of the present invention are attained by employing a reduced diameter optical fibre preform and a method of manufacturing thereof.

### BRIEF DESCRIPTION OF THE DRAWINGS

So that the manner in which the above recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a pictorial representation illustrating a cross-sectional view of a reduced diameter optical fibre preform in accordance with an embodiment of the present invention;

FIG. 1B is a block diagram illustrating the reduced diameter optical fibre preform in accordance with an embodiment of the present invention;

FIG. 2 is a flow chart illustrating a method of manufacturing the reduced diameter optical fibre preform in accordance with an embodiment of the present invention.

### ELEMENT LIST

Reduced diameter optical fibre preform —100
Longitudinal axis —102
Core section —104
Cladding section —106

The method and the reduced diameter optical fibre preform are illustrated in the accompanying drawings, throughout which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DETAILED DESCRIPTION OF THE INVENTION

The present invention relates to a reduced diameter optical fibre preform and a method of manufacturing thereof.

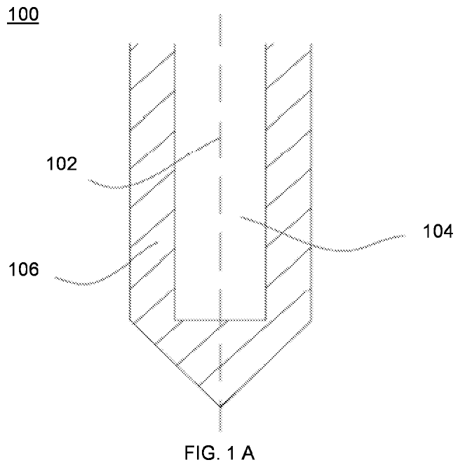

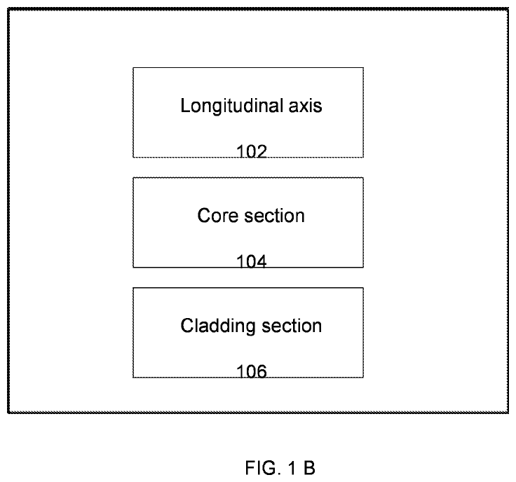

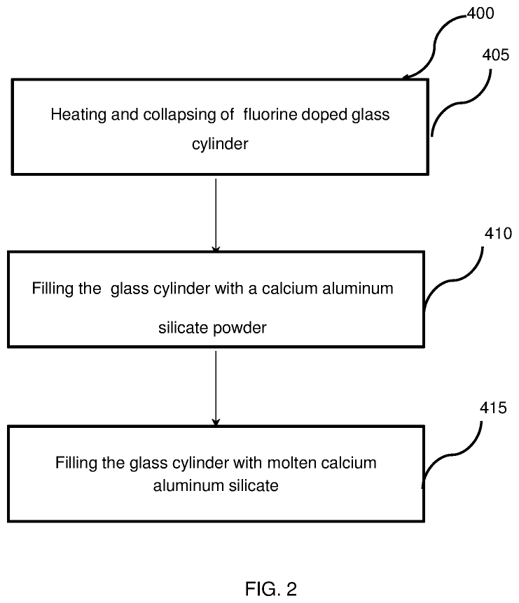

The principles of the present invention and their advantages are best understood by referring to FIG. 1A to FIG. 2. In the following detailed description numerous specific details are set forth in order to provide a thorough understanding of the embodiment of invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The following brief definition of terms shall apply throughout the present invention:

Optical fibre is used for transmitting information as light pulses from one end to another. In addition, optical fibre is a thin strand of glass or plastic capable of transmitting optical signals. Further, optical fibre allows transmission of information in the form of optical signals over long distances. Furthermore, optical fibre is used for a variety of purposes. The variety of purposes includes telecommunications, broadband communications, medical applications, military applications and the like.

Refractive index of a material is the ratio of speed of light in vacuum to speed of light in material.

Density of a material is the mass of a substance per unit volume of substance.

Coefficient of thermal expansion is a measure of change in size of an object with respect to change in temperature.

Glass transition temperature of a material is the temperature at which glass transition occurs.

Glass transition is the gradual and reversible transition in amorphous materials from a hard and relatively brittle state into a viscous or rubbery state.

Viscosity of a fluid is fluid's resistance to gradual deformation by shear stress or tensile stress.

Rod-in-cylinder corresponds to a process in which a cylinder is locally heated and collapsed onto a core rod

Referring to FIGS. 1A and 1B, illustrating the reduced diameter optical fibre preform 100, in accordance with one or more embodiments of the present invention. In particular, optical fibre preform is a glass body used to draw an optical fibre. The reduced diameter optical fibre preform 100 is drawn or pulled to form the optical fibre. The reduced diameter optical fibre preform 100 is a cylindrical body of glass. In particular, the reduced diameter optical fibre preform 100 is positioned along a longitudinal axis 102. And, the longitudinal axis 102 is an imaginary axis passing through the geometrical center of the reduced diameter optical fibre preform 100. Moreover, the reduced diameter optical fibre preform 100 includes a core section 104 and a cladding section 106.

Particularly, the core section 104 is the inner part of the reduced diameter optical fibre preform 100 and cladding section 106 which is an outer part of the reduced diameter optical fibre preform 100. And, the core section 104 is defined as a region around the longitudinal axis 102 of the reduced diameter optical fibre preform 100. Moreover, the core section 104 extends radially outward from the longitudinal axis 102 of the reduced diameter optical fibre preform 100. Further, the cladding section 106 circumferentially surrounds the core section 104 of the reduced diameter optical fibre preform 100.

In accordance with an embodiment of the present invention, the core section 104 and the cladding section 106 are formed during manufacturing stage of the reduced diameter optical fibre preform 100. The core section 104 has a refractive index greater than the refractive index of the cladding section 106. In an embodiment of the present invention, refractive index is maintained as per desired level based on concentration of chemicals used to manufacture the reduced diameter optical fibre preform 100.

In accordance with an embodiment of the present invention, the core section 104 of the reduced diameter optical fibre preform 100 is formed of calcium aluminum silicate. In particular, the core section 104 formed of calcium aluminum silicate is multi-component. Alternatively, the core section 104 is formed of any suitable material of the like. Further, the core section 104 is characterized by low attenuation. The attenuation of the core section 104 is about 0.1 decibel per kilometer.

In alternate embodiment of the present invention, the core section 104 has any suitable attenuation of the like. The core section 104 is characterized by a first refractive index. Particularly, the first refractive index of core section 104 is about 1.625. Alternatively, the first refractive index of the core section 104 may vary.

In accordance with an embodiment of the present invention, the core section 104 is characterized by a density. In particular, the density of the core section 104 is about 2.8 grams per cubic centimeters. Alternatively, the density of the core section 104 may vary. Moreover, the core section 104 is characterized by a coefficient of thermal expansion. The coefficient of thermal expansion of the core section 104 is about 5.1×10⁻⁶.per kelvin. Alternatively, the coefficient of thermal expansion of the core section 104 may vary. Further, the core section 104 is characterized by a glass transition temperature. In particular, the glass transition temperature of the core section 104 is about 830° Celsius. Alternatively, the glass transition temperature of the core section 104 may vary.

In accordance with an embodiment of the present invention, the cladding section 106 of the reduced diameter optical fibre preform 100 is formed of fluorine doped glass. In particular, the fluorine doped glass is characterized by a lower viscosity as compared to non-doped glass. Moreover, the cladding section 106 is formed of glass doped with fluorine to a suitable concentration.

In an embodiment of the present invention, the cladding section 106 of the optical fibre preform 100 is formed of aluminum silicate. In particular, the cladding section 106 is formed of aluminum silicate to match thermal properties of the core section 104 formed of calcium aluminum silicate. The cladding section 106 is characterized by a second refractive index. In particular the second refractive index of the cladding section 106 is about 1.54. Alternatively, the second refractive index of the cladding section 106 may vary. Moreover, the density of the cladding section 106 is about 2.7 grams per cubic centimeters. Alternatively, the density of the cladding section 106 may vary. Furthermore, the coefficient of thermal expansion of the cladding section 106 is about 4.7×10⁻⁶.per Kelvin. Alternatively, the coefficient of thermal expansion of the cladding section 106 may vary. And, the glass transition temperature of the cladding section 106 is about 790° Celsius. Alternatively, the glass transition temperature of the cladding section 106 may vary.

In an alternate embodiment of the present invention, the core section 104 is characterized by a first diameter. In particular, the first diameter of the core section 104 is 25 to 28 Micron. The core section 104 may have any suitable value of the first diameter. Moreover, the cladding section is characterized by a second diameter. The second diameter is the external diameter of the cladding section 106. Subsequently, the second diameter of the cladding section 106 is about 41 millimeters. Alternatively, the cladding section 104 has any suitable value of the second diameter. The cladding section 106 has a lower refractive index than the core section 104.

The reduced diameter optical fibre preform 100 is characterized by an outer diameter. The outer diameter is the overall external diameter of the reduced diameter of the optical fibre preform 100. Particularly, the reduced diameter optical fibre preform 100 includes a single cladding layer. Alternatively, the reduced diameter optical fibre preform 100 is without over-cladding layers. The reduced diameter optical fibre preform 100 is low cost due to absence of the over-cladding layers. The reduced diameter optical fibre preform 100 is used for manufacturing of multi-mode optical fibres. In an embodiment of the present invention, the reduced diameter optical fibre preform 100 is used for manufacturing of any suitable optical fibre of the like including but not limited to single mode optical fibres and multi mode optical fibres.

In accordance with an embodiment of the present invention, the optical fibre preform 100 is used for manufacturing multimode optical fibre. The optical fibre preform 100 has a specific design. The specific design of optical fibre preform 100 is obtained by unique selection of materials and manufacturing process. In addition, the optical fibre preform 100 enables drawing of the optical fibre with low transmissions losses. Further, the optical fibre preform 100 is characterized by lower manufacturing cost and enables drawing of the optical fibre having low attenuation.

FIG. 2 is a flow chart illustrating a method for manufacturing reduced diameter optical fibre preform in accordance with an embodiment of the present invention. Method 400 starts at step 405 and proceeds to step 410, 415. At step 405, a fluorine doped glass cylinder is heated and collapsed onto a calcium aluminum silicate rod. In particular, the fluorine doped glass cylinder is hollow cylinder, wherein the fluorine doped glass cylinder is heated and collapsed onto a calcium aluminum silicate rod. Moreover, the calcium aluminum silicate rod is placed inside the fluorine doped glass cylinder. Further, the fluorine doped glass cylinder containing the calcium aluminum silicate rod is heated from outside to enable the reduced diameter optical fibre preform (100).

At step 410, fluorine doped glass cylinder is filled compactly with the calcium aluminum silicate powder. In particular, calcium aluminum silicate powder solidifies and adheres smoothly with the fluorine doped glass cylinder after sintering for manufacturing of the reduced diameter optical fibre preform.

At step 415, fluorine doped glass cylinder is filled compactly with the melted calcium aluminum silicate. In particular, the melted calcium aluminum silicate adheres smoothly with the fluorine doped glass cylinder after cooling for manufacturing the reduced diameter optical fibre preform 100.

In accordance with an embodiment of the present invention, the reduced diameter optical fibre preform 100 is manufactured by adopting a plurality of manufacturing techniques. The plurality of manufacturing techniques includes but may not be limited to rod-in-cylinder methods. The reduced diameter optical fibre preform 100 is manufactured by utilizing the rod-in-cylinder method by inserting a core rod assembly inside a hollow clad cylinder. In particular, the reduced diameter optical fibre preform 100 obtained from the rod-in-cylinder method is directly drawn to yield the optical fibre. Alternatively, the reduced diameter optical fibre preform 100 obtained from the rod-in-cylinder method is stretched to form a plurality of solid preform rods having small diameter. Further, the plurality of solid preform rods is further drawn to yield optical fibers.

In another aspect of the present invention, the reduced diameter optical fibre preform 100 is manufactured by utilizing a calcium aluminum silicate rod and a fluorine doped glass cylinder. Particularly, the calcium aluminum silicate rod is placed inside the fluorine doped glass cylinder. Moreover, the fluorine doped cylinder containing calcium aluminum silicate is processed to enable manufacturing of the reduced diameter optical fibre preform 100. Further, the fluorine doped glass cylinder is heated from outside. The calcium aluminum silicate rod in solid state is placed inside the fluorine doped glass cylinder.

In yet another aspect of the present invention, the fluorine doped glass cylinder is heated and collapsed onto the calcium aluminum silicate rod. Particularly, the fluorine doped glass cylinder after collapsing and cooling adheres smoothly with the calcium aluminum silicate rod to manufacture the reduced diameter optical fibre preform 100. Alternatively, the fluorine doped cylinder containing calcium aluminum silicate is processed by any suitable method of the like. Moreover, the fluorine doped glass cylinder is characterized by the internal diameter of the hollow section of the fluorine doped glass cylinder. The internal diameter of the fluorine doped glass cylinder is in a range of about 26 millimeters to 28 millimeters. Alternatively, the fluorine doped glass cylinder has any suitable value of internal diameter.

In yet another aspect of the present invention, the plurality of manufacturing techniques includes placing calcium aluminum silicate powder in the fluorine doped glass cylinder. In particular, the fluorine doped cylinder is filled compactly with calcium aluminum silicate powder. Moreover, the fluorine doped cylinder with calcium aluminum silicate powder is processed to manufacture the reduced diameter optical fibre preform 100. Furthermore, the plurality of manufacturing techniques includes sintering of the calcium aluminum silicate powder inside the fluorine doped glass cylinder. The calcium aluminum silicate powder after sintering solidifies and adheres smoothly with the fluorine doped glass cylinder to enable the reduced diameter optical fibre preform 100. Alternatively, the fluorine doped glass cylinder with calcium aluminum silicate powder is processed by any suitable method of the like. The fluorine doped glass cylinder has internal diameter in a range of about 26 millimeters to 28 millimeters.

Alternatively, the plurality of manufacturing techniques includes placing molten calcium aluminum silicate in the fluorine doped glass cylinder. The fluorine doped glass cylinder is filled compactly with molten calcium aluminum silicate. Particularly, the fluorine doped glass cylinder with molten calcium aluminum silicate is processed to manufacture the reduced diameter optical fibre preform 100. Furthermore, the plurality of manufacturing techniques includes cooling of the molten calcium aluminum silicate placed in the fluorine doped glass cylinder. The molten calcium aluminum silicate after cooling adheres smoothly with the fluorine doped glass cylinder to manufacture the reduced diameter optical fibre preform 100. In an embodiment of the present invention, the fluorine doped glass cylinder with molten calcium aluminum silicate is processed by any suitable method of the like.

It may be noted that the method 200 is explained to have above stated process steps, however, those skilled in the art would appreciate that the method 200 may have more/less number of process steps which may enable all the above stated embodiments of the present invention.

The present invention for optical fibre preform and method of manufacturing thereof to provide a low loss optical fibre with reduced manufacturing cost, manufactured without over cladding layer, matching thermal properties of core and cladding of the optical fibre preform, low attenuation losses, and for manufacturing of low loss optical fibres.

The foregoing descriptions of pre-defined embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A reduced diameter optical fibre preform comprising:
a core section, defined around a longitudinal axis of the reduced diameter optical fibre preform, wherein the core section extends radially outward from the longitudinal axis of the reduced diameter optical fibre preform; and
a cladding section, wherein the cladding section circumferentially surrounds the core section of the reduced diameter optical fibre preform.

2. The reduced diameter optical fibre preform as claimed in claim 1, wherein the core section is made of calcium aluminum silicate.

3. The reduced diameter optical fibre preform as claimed in claim 2, wherein the core section has a first refractive index of 1.625

4. The reduced diameter optical fibre preform as claimed in claim 2, wherein the core section of the optical fibre preform has a coefficient of thermal expansion of 5.1×10⁻⁶ per Kelvin.

5. The reduced diameter optical fibre preform as claimed in claim 2, wherein the core section has a glass transition temperature of 830 degree Celsius.

6. The reduced diameter optical fibre preform as claimed in claim 1, wherein the cladding section is made of a fluorine doped glass.

7. The reduced diameter optical fibre preform as claimed in claim 1, wherein the cladding section is made of an aluminium silicate.

8. The reduced diameter optical fibre preform (100) as claimed in claim 6, wherein the cladding section has a second refractive index 1.54.

9. The reduced diameter optical fibre preform as claimed in claim 6, wherein the cladding section of the optical fibre preform has a coefficient of thermal expansion of 4.7×10⁻⁶.per Kelvin.

10. The reduced diameter optical fibre preform as claimed in claim 6, wherein the cladding section of the optical fibre preform has a glass transition temperature of 790 degree Celsius.

11. The reduced diameter optical fibre preform as claimed in claim 6, wherein the cladding section has a density of 2.7 grams per cubic centimeters.

12. The reduced diameter optical fibre preform as claimed in claim 2, wherein the core section has a density of 2.8 grams per cubic centimeters.

13. The reduced diameter optical fibre preform as claimed in claim 1, wherein the core section is characterized by an attenuation, and the core section has the attenuation of 0.1 decibel per kilometer.

14. The reduced diameter optical fibre preform as claimed in claim 1, wherein the reduced diameter optical fibre preform has an outer diameter of 41 millimeters.

15. A method for manufacturing a reduced diameter optical fibre preform comprising at least one step of:
heating and collapsing of a fluorine doped glass cylinder onto a calcium aluminum silicate rod, and the fluorine doped glass cylinder is hollow cylinder;
filling the fluorine doped glass cylinder compactly with a calcium aluminum silicate powder; and
filling the fluorine doped glass cylinder compactly with a molten calcium aluminum silicate, wherein the melted calcium aluminum silicate adheres smoothly with the fluorine doped glass cylinder after cooling for manufacturing the reduced diameter optical fibre preform.

16. The method for manufacturing the reduced diameter optical fibre preform as claimed in claim 15, wherein the fluorine doped glass cylinder has an internal diameter in range of 26 millimeters to 28 millimeters.

17. The method for manufacturing the reduced diameter optical fibre preform as claimed in claim 15, wherein the calcium aluminum silicate rod is placed inside the fluorine doped glass cylinder,

18. The method for manufacturing the reduced diameter optical fibre preform as claimed in claim 15, wherein the fluorine doped glass cylinder containing the calcium aluminum silicate rod is heated from outside to enable the reduced diameter optical fibre preform.

19. The method for manufacturing the reduced diameter optical fibre preform as claimed in claim 15, wherein the calcium aluminum silicate powder solidifies and adheres smoothly with the fluorine doped glass cylinder after sintering for manufacturing of the reduced diameter optical fibre preform.

20. The method for manufacturing the reduced diameter optical fibre preform as claimed in claim 15, wherein the reduced diameter optical fibre preform has an outer diameter of 41 millimeters.
